(19) United States
(12) Patent Application Publication
(10) Pub. No.: US 2007/0187023 A1
(43) Pub. Date: Aug. 16, 2007

(54) METHOD OF MAKING A POLARIZER AND POLARIZING SHEET THEREOF

(76) Inventors: Cheng-Hsin Tsai, Tao-Yuan City (TW); Chung-Neng Fu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/737,131

(22) Filed: Apr. 18, 2007

Related U.S. Application Data
(63) Continuation-in-part of application No. 11/164,826, filed on Dec. 7, 2005.
(63) Continuation-in-part of application No. 11/397,403, filed on Apr. 4, 2006.

(30) Foreign Application Priority Data
Sep. 11, 2006 (TW) 095133437
Nov. 15, 2005 (TW) 094140099

(51) Int. Cl. B32B 38/14; B32B 38/00; B32B 38/12; B05D 3/00; B05D 1/18; B05D 5/06

(52) U.S. Cl. 156/229; 156/278; 427/430.1; 427/163.1; 427/299

(57) ABSTRACT

A method of making a polarizer includes providing a polyvinyl alcohol (PVA) film; dipping the PVA film into a dye solution for dyeing; dipping the PVA film into a first solution for pre-treatment; and dipping the pretreated PVA film into a second solution while stretching the PVA film. The first solution contains dicarboxylic acid and a catalyst for catalyzing the reaction between the dicarboxylic acid and the surface of the PVA film, and does not contain boric acid. The second solution contains boric acid.

### CROSS REFERENCE TO RELATED APPLICATIONS

This is a continuation-in-part of U.S. application Ser. No. 11/397403 filed Apr. 4, 2006 and U.S. application Ser. No. 11/164826 filed Dec. 7, 2005.

### BACKGROUND OF THE INVENTION

1. Field of the Invention

The present invention relates generally to the manufacture of a polarizer and, more particularly, to a method for manufacturing a polarizer applied to a liquid crystal display (LCD).

2. Description of the Prior Art

A polarizer is an essential component in LCDs, which polarizes a laterally oscillating light into a linearly polarized light. The polarized light and the twisting nature of liquid crystal molecules combine to control passage of light and performance of a color signal. Today, polarizers, or polarizing sheets, are widely used in the production of LCD devices for cell phones, watches, calculators, personal computers, monitors, electronic clocks, word-processors, automobiles, liquid crystal televisions, etc. And, LCD devices are increasingly used in relatively severer environments, such as, for example, outdoor commercial displays, in-car GPS screens, navigation systems of vehicles, and satellites. The market demand for polarizing sheets with high polarization performance has increased with the increased use of such LCD devices.

FIG. 1 is a schematic cross-sectional diagram of a polarizing sheet 10 according to the prior art. Typically, the polarizing sheet 10 includes an adhesive release film 12, a pressure-sensitive adhesive film 14, a polyvinyl alcohol (PVA) polarizing base film 18, triacetyl cellulose (TAC) films 16 and 20, and a protective film 22. In some cases, an anti-glare coating, or an anti-reflection coating, may be applied to the polarizing sheet 10. Currently, iodine-type polarizing sheets are more prevalent than other types, because of their high optical performance (including high light transmittance, high contrast, and wide range of wavelengths), easy production process, and low cost.

Generally, a manufacture of the iodine-type polarizing sheet will perform a treatment process on raw PVA material, including the steps of swelling, dyeing, rinsing (optional), and re-stretching, to form the PVA polarizing base film 18, which functions as a polarizer. Then, the TAC films 16 and 20, which are pre-treated with an alkaline solution, such as sodium hydroxide or potassium hydroxide, are adhered onto the PVA polarizing base film 18 by applying a PVA-containing hydrogel to two opposite sides of the PVA polarizing base film 18. After drying, the protective film 22 is laminated on the TAC film 20, and the pressure-sensitive adhesive 14 is coated on the TAC film 16, along with the adhesive release film 12 laminated thereon, to form the polarizing sheet 10.

The re-stretching process is usually performed in a solution comprising boric acid and potassium iodide. In this process, boric acid, which is a cross-linking agent, can cross-link with a surface of the PVA film. Boric acid promotes color fixation and increases tenacity of the PVA film, such that the PVA film can readily stretch in the solution. However, the sides and center of the PVA film sometimes have significantly different thicknesses after stretching, because the high tenacity of the PVA film makes stretching thereof difficult. If the quantity of boric acid used in the process is decreased, poor color fixation may occur. Further, cross-linking between boric acid and the surface of the PVA film limits the stretchability of the PVA film, thus narrowing the width of the polarizer. In this case, the total stretching ratio of the polarizer film is normally less than 6. The above-mentioned shortcomings lead to low utility of such kinds of polarizer and high production cost.

In another aspect, the polarizing sheet 10 comprises at least five optical films (the adhesive release film 12, the PVA polarizing base film 18, the TAC films 16 and 20, and the protective film 22). Since different materials react differently to heat and moisture, the polarizing sheet may peel off from the glass substrate of the LCD panel because of the accumulated stress. Under hot and moist conditions, of the aforesaid optical films, the PVA polarizing base film 18 shrinks the most, thus the PVA polarizing base film 18 produces the largest stress out of the optical films. One conventional solution is to make the thickness of the PVA polarizing base film 18 less than 30 μm. The preferred thickness is less than 27 μm. Although the thickness of the PVA polarizing base film 18 could be decreased by altering the composition of the cross-linking solution and the design of the manufacturing machine in the traditional process, using boric acid as a cross-linking reagent, this often results in deterioration of the optical performance of the polarizer film.

Therefore, a better method for manufacturing a polarizer/polarizing sheet is needed to increase the utilization rate of materials (increasing the width of the PVA film and raising the total stretching ratio), and at the same time, to maintain good optical performance of the polarizer/polarizing sheet.

### SUMMARY OF THE INVENTION

It is one objective of the present invention to provide a method to increase the utilization rate of materials (increased width of the PVA film and raised total stretching ratio) and manufacturing a polarizer/polarizing sheet having good optical performance.

According to the present invention, a method of making a polarizer comprises preparing a polyvinyl alcohol (PVA) film, performing a dyeing process by dipping the PVA film into a dye-containing solution, performing a pre-treating process by dipping the PVA film into a first solution, wherein the first solution does not contain boric acid and comprises dicarboxylic acid and a catalyst that catalyzes a surface reaction between the dicarboxylic acid and the PVA film, and dipping the pre-treated PVA film in a second solution and stretching the PVA film, wherein the second solution comprises boric acid.

According to the present invention, by laminating the polarizer made by the method described above with a support film, a polarizing sheet can be obtained.

The term “polarizer” or also called “polarizing film” herein refers to as a film or layer having a function of polarization among all layers of a polarizing sheet. For example, a polarizer contains iodine or dichroic dyestuffs.

The method of making polarizer or polarizing sheet in the present invention has advantages below:

(1) The thickness of the polarizer is decreased, and the width and total stretching ratio of the polarizer are increased.

(2) The optical performance is still as good as that in the conventional process.

(3) The process taught in the present invention can be integrated into the conventional process easily.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional diagram of a polarizing sheet according to the prior art.

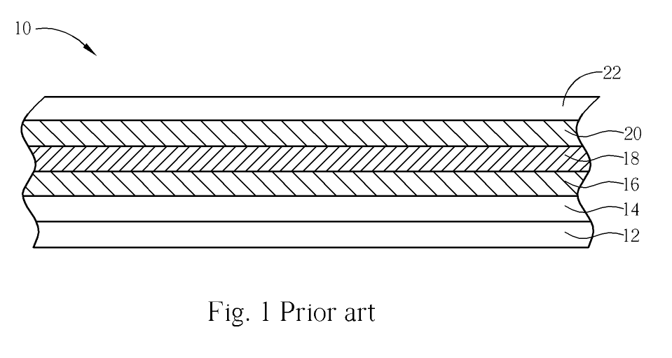

FIG. 2 is a diagram showing a process of manufacturing a polarizing sheet according to U.S. Patent publication Ser. No. 11/164826.

FIG. 3 is a diagram of the method of making polarizing sheets according to the present invention.

FIG. 4 is a diagram of a surface configuration of the PVA film after pre-treatment.

FIG. 5 is a diagram showing the disposition of tanks according to the prior art.

FIG. 6 is a table comparing the preferred example with two comparison examples in the present invention.

### DETAILED DESCRIPTION

Applicant's co-pending U.S. patent application Ser. No. 11/164826 (hereafter '826) filed Dec. 7, 2005 provides a method for overcoming troublesome preparation steps for an aqueous hydrogel in making the polarizing sheet. The summary of '826 is as follows.

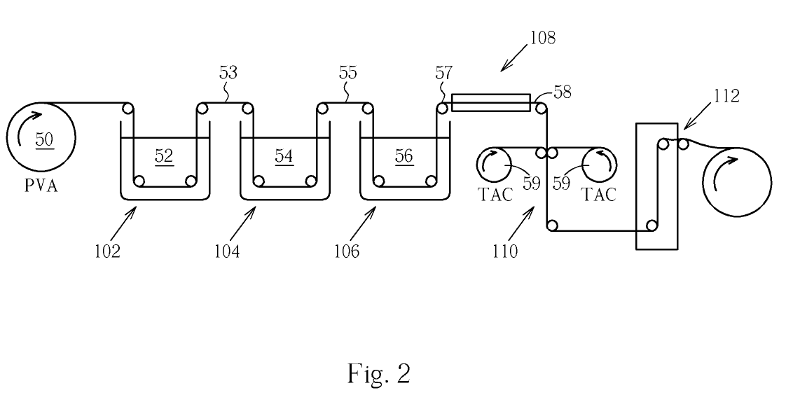

Please refer to FIG. 2. FIG. 2 is a schematic diagram showing the process in '826, which includes:

Step 102: swelling;

Step 104: dyeing;

Step 106: stretching;

Step 108: drying;

Step 110: lamination; and

Step 112: drying.

Starting with Step 102, an un-stretched PVA film 50 is dipped in pure water 52 for swelling to form a swelled PVA film 53. After the swelling process, the swelled PVA film 53 is carried in Step 104. In Step 104, the swelled PVA film 53 is dipped into a dyeing solution 54 to adsorb iodine, forming a dyed PVA film 55. Next, the dyed PVA film 55 is stretched in Step 106. Step 106 is a uniaxial stretching process. During the uniaxial stretching process, the dyed PVA film 55 is dipped into a cross-linking solution 56 containing boric acid and potassium iodide with boric acid concentration of 1 wt. % to 10 wt. %. The cross-linking solution 56 further comprises a dicarboxylic acid, such as adipic acid, glutaric acid, or succinic acid. The dicarboxylic acid of the cross-linking solution 56 reacts with surface hydroxyl groups of the dyed PVA film 55 during the stretching in Step 106. Concentration of the dicarboxylic acid is between 1 wt. % and 5 wt. %.

Step 108 (the drying process before lamination) is then carried out to dry the dyed PVA film 55, forming a dried PVA film 57, which is treated in Step 106. In Step 110, triacetyl cellulose (TAC) films 59 treated by alkaline solution are laminated on both sides of the dried PVA film 58 to form a TAC-PVA-TAC laminate film. Finally, in Step 112, the TAC-PVA-TAC laminate film is dried to form a polarizing sheet.

In '826, boric acid is partly or completely replaced by adipic acid, which functions as a cross-linking agent to aid in stretching. When the PVA film is stretched in the stretching tank filled with heated adipic acid solution (40° C. to 60° C., preferably 50° C. to 55° C., more preferably 51° C. to 53° C.), and a proper amount of catalyst is added, ester bonds will be formed on the surface of the PVA film. This is because the PVA film has a lot of hydroxyl groups on its surface, and adipic acid is an organic acid.

A single bonding structure of the adipic acid increases adhesion between the PVA film and the hydrogel (if used in the subsequent lamination process). A double bonding structure of the adipic acid can increase the stretchability of the PVA film, thus even at a high stretching ratio, the PVA film will not break. Because the stretchability is increased, in combination with proper adjustment of stretching parameters, a thinner and wider PVA film can be obtained. Further, because the thickness of the PVA film is decreased, a heat shrinkage rate (measured by thermal mechanical analysis) of the polarizing sheets after the TAC lamination process is improved.

However, the invention disclosed in '826 has some drawbacks. First, because the stretchability of the PVA film is increased, the side thickness of the PVA film differs greatly from a centric thereof. Compared to boric acid, adipic acid increases the stretchability of the PVA film, but the adipic acid has a poorer color fixation effect on iodine and potassium iodide in the PVA film. The poorer color fixation effect leads to significant loss of iodine and potassium iodide in the stretching tank, and optical performance (e.g. polarizing efficiency, transmittance, or hue) of the PVA film (polarizer) is thus adversely affected. This drawback can be improved upon by adjusting composition of the reacting solution, but it causes a great change in the manufacturing process. In addition, the heat and moisture resistance of the polarizer/polarizing sheet can be improved by treating the polarizer/polarizing sheet with boric acid, so when boric acid is replaced by adipic acid, the reliability of the polarizer/polarizing sheet decreases.

To overcome this problem, the present invention replaces boric acid in the rinsing tank normally used before stretching in the stretching tank in the traditional process with dicarboxylic acid in order to form a pre-treating solution. Therefore, the stretchability of the PVA film can be increased by the dicarboxylic acid. At the same time, the PVA film is still immersed for enough time in the boric acid solution of the stretching tank, so the reliability of the PVA film is not influenced. And, polarizers with a higher stretching ratio, wider width, higher utility of material, and improved optical performance are formed. Further, because the thickness of the PVA film is decreased along with the increase of the stretchability, the PVA film formed has better heat tolerance.

The method of making the polarizer in the present invention comprises: preparing a polyvinyl alcohol (PVA) film; performing a dyeing process by dipping the PVA film into a dye-containing solution; performing a pre-treating process by dipping the PVA film into a first solution, wherein the first solution does not contain boric acid and comprises dicarboxylic acid and a catalyst that catalyzes a surface reaction between the dicarboxylic acid and the PVA film; and dipping the PVA film in a solution of the stretching tank to stretch the PVA film, wherein the solution of the stretching tank comprises boric acid.

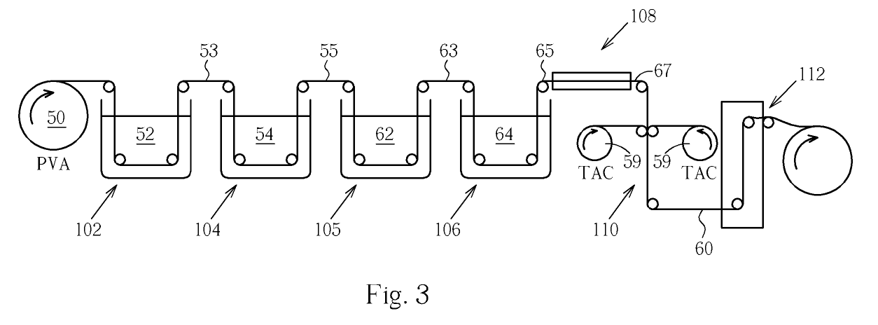

Please refer to FIG. 3. FIG. 3 is an embodiment of making polarizing sheets by further utilizing the polarizer formed according to the method disclosed in the present invention. The process generally includes the following steps:

Step 102: swelling;

Step 104: dyeing;

Step 105: pre-treatment;

Step 106: stretching;

Step 108: drying;

Step 110: lamination; and

Step 112: drying.

Steps 104, 105, and 106 are primary steps in making the polarizer of the present invention. Step 104 can be performed before or after Steps 105 and 106. Step 102 is optional. The rinsing process can be performed several times after dyeing or stretching. Additionally, a PVA film is stretched uniaxially in every tank during the process of fabricating the polarizer. A stretching ratio used in each tank can be different. The polarizing sheets can be obtained by laminating the polarizers in Step 110. Step 108 and Step 112 can be performed before and after Step 110, respectively.

Starting with Step 102, an un-stretched PVA film 50 is dipped in pure water 52 for swelling to form a swelled PVA film 53. In Step 104, the swelled PVA film 53 is then dipped into a dye solution 54, such as a solution containing iodine, to adsorb iodine and form a dyed PVA film 55. The dye solution 54 basically contains molecular iodine and potassium iodide with an iodine concentration (including molecular iodine and ionic iodine) of about 0.01 wt. % to 1 wt. %.

In Step 105, the dyed PVA film 55 is placed in a pre-treating solution 62 comprising dicarboxylic acid and a catalyst that catalyzes a reaction between the dicarboxylic acid and hydroxyl groups on a surface of the dyed PVA film 55. Aqueous solution is preferred for the pre-treating solution. The dicarboxylic acid is an organic acid such as succinic acid, glutaric acid, adipic acid, or pimelic acid, or a derivative thereof having two carboxylic groups. Taking adipic acid as an example, whose molecular formula is HOOCC₄H₈COOH, is a dicarboxylic acid comprising six carbon atoms, thus adipic acid has a different spatial configuration. Considering molecular characteristics, solubility in water, and gaining source, adipic acid is a preferred dicarboxylic acid.

Concentration of the dicarboxylic acid is not limited, as long as the dicarboxylic acid forms bonds with the surface of the PVA film, and is fully dissolved in the pre-treating solution at a preset temperature. For example, the concentration of the dicarboxylic acid in the pre-treating solution could be in a range of 1 wt. % to 5 wt. %, a better range being between 2 wt. % and 4 wt. %, and a much better range being between 2 wt. % and 3 wt. % (taking the pre-treating solution as total weight). Taking adipic acid as example, solubility is usually less than 4 wt. % at room temperature. The solubility of adipic acid can be increased by increasing temperature.

The catalyst can be a Lewis acid, such as zinc or aluminum ions, or metal salts or complexes containing zinc or aluminum ions, which can provide Zn²⁺ or Al³⁺, such as ZnCl₂, AlCl₃, Al₂(SO₄)₃. When environmental pollution is considered, Al³⁺ is preferred.

The concentration of the catalyst is not limited, as long as the catalytic reaction can be carried out. Taking Al³⁺ as an example, there is no special restriction on the concentration of Al³⁺. Any concentration of Al³⁺ that helps the catalytic reaction can be used. The concentration of Al³⁺ can be in a range of 0.01 wt. % to 5 wt. %, with a better range being between 0.01 wt. % and 3 wt. %, and a much better range being between 0.01 wt. % and 1 wt. % (taking the pre-treating solution as total weight).

The temperature of the pre-treating solution is in a range of 30° C. to 50° C., and preferably 30° C. to 40° C.

In the conventional art, the PVA film is typically rinsed in a first rinsing tank containing boric acid and potassium iodide after the dyeing process and before the stretching processes, and meanwhile, the PVA film is stretched to 1 to 2 times its original size. In the present invention, the solution of the first rinsing tank is replaced by the pre-treating solution, and the first rinsing tank becomes a pre-treating tank, thus making it easy to modify the manufacturing process. The pre-treating solution includes dicarboxylic acid and the catalyst, but does not contain boric acid. In the stretching tank, the PVA film modified by dicarboxylic acid can be stretched to 1 to 2 times its original size easily, or can be stretched to other ratios. The stretching ratio can be adjusted according to different requirements. Because the PVA film is not dipped in the pre-treating solution for a long period of time, the absence of boric acid does not cause cracks/breaks in the PVA film when only stretched slightly.

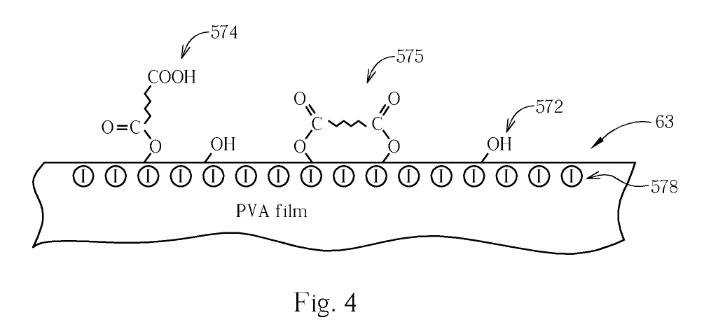

Please refer to FIG. 4. FIG. 4 is a schematic diagram of the surface configuration of the PVA film 63 after pre-treating in Step 105. Taking adipic acid as an example, in Step 105, adipic acid has two carboxyl groups on two sides of the molecular chain, respectively. One of the carboxyl groups forms ester bonds 574 with hydroxyl groups 572 on the surface of the PVA film, or both carboxyl groups of the adipic acid form ester bonds 575 with the hydroxyl groups 572 on the surface of the PVA film, respectively.

The pre-treating solution can further comprise potassium iodide to enhance the dyeing of the polarizer. The concentration of potassium iodide is around 1 wt. % to 5 wt.

In Step 106, the pre-treated PVA film 63 is stretched by a uniaxial stretching process utilizing a stretching solution 64 containing boric acid and potassium iodide. The concentration of boric acid can be the concentration used in the conventional process, e.g. 1 wt. % to 10 wt. %, and the concentration of potassium iodide can be the concentration used in the conventional process, e.g. 1 wt. % to 5 wt. %.

The stretched PVA films can be rinsed, optionally. For example, the PVA films can be rinsed in a second rinsing tank used in the conventional process, or the color fixation process can be performed in a fixation tank, optionally. The second rinsing tank and the fixation tank may comprise KI and boric acid, and the concentration thereof can be adjusted for different requirements. The preferred concentration of KI and boric acid is about 1 wt. % to 5 wt. %, respectively. The ratio of KI to boric acid in the rinsing tank and/or the fixation tank is usually equal to that in the stretching tank, thus the properties of the PVA film can be improved. The rinsing process can be performed again if required. A third rinsing tank used in the conventional process can be used to rinse the PVA film. Ice water (around 10° C. or lower) is used to remove chemical residue, such as boric acid, on the surface of the PVA film. Then, the PVA film 65 is formed into a polarizer.

Step 108 can be further carried out to dry the PVA film 65 (drying process before lamination).

In Step 110, triacetyl cellulose (TAC) films 59 are laminated on the PVA film 67 to form a TAC-PVA-TAC stacked film. There are no special restrictions on the lamination process. The lamination process can be carried out by laminating with hydrogel.

Finally, in Step 112, the TAC-PVA-TAC stacked film 60 is subjected to a drying process, such as drying at 50° C. to 80° C., to form a polarizing sheet.

Further, in order to improve the function of the polarizing sheet, the TAC films may be coated with, for example, a liquid crystal layer, a protective layer, an anti-glare layer, an anti-reflection layer, or anti-scratch or anti-smear layers in advance. By combining TAC films with different functions, polarizing sheets with different optical performance and/or functions can be obtained.

To explain the features and advantages of this invention further, one preferred example (best mode) and two comparison examples are demonstrated as below.

### PREFERRED EXAMPLE (BEST MODE):

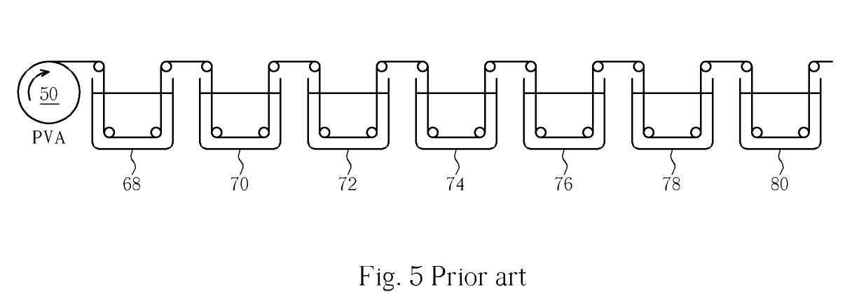

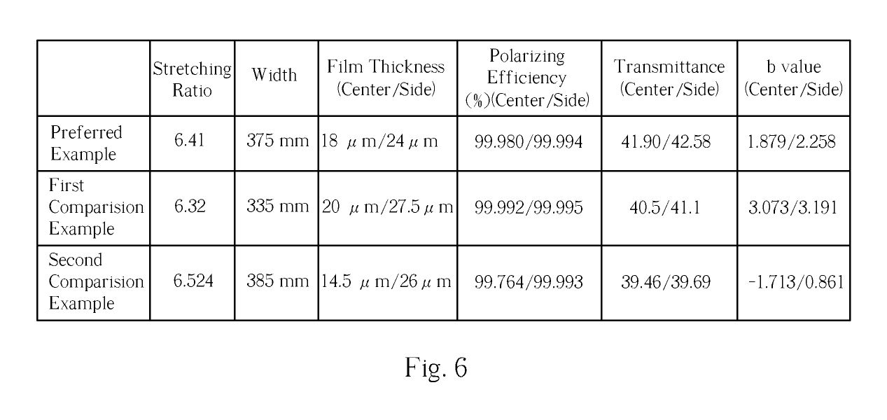

Please refer to FIG. 5. FIG. 5 is a schematic diagram showing a disposition of tanks according to the prior art. The unstretched PVA films 50 (width 650 mm, thickness 75 μm) are swelled in the swelling tank 68 with pure water, and then dyed in the dyeing tank 70, which comprises an iodine solution of concentration between 0.01 wt. % to 1 wt. %. The first rinsing tank 72 of the conventional art is taken as the pre-treating tank in the present invention. The dyed PVA films are put in the pre-treating tank comprising the pre-treating solution. The pre-treating solution comprises 2.56 wt. % adipic acid, 0.3 wt. % Al₂(SO₄)₃·16−18H₂O, and 3.3 wt. % KI, and the temperature of the pre-treating solution is 35° C. Then, the pre-treated PVA film is stretched in the stretching tank 74, the temperature of the stretching tank 74 being 51° C. Next, the stretched PVA film is rinsed in the second rinsing tank 76, treated in the color fixation tank 78, optionally rinsed in the third rinsing tank 80 containing ice water (about 10° C.), and finally dried at 60° C. to form the polarizers. In the Preferred Example, the PVA film is not rinsed in the third rinsing tank 80. The stretching tank 74, the second rinsing tank 76, and the color fixation tank 78 comprise boric acid and KI, and the concentration of the boric acid and/or the KI can be adjusted as required, preferably independent of the other, and being in a range of 1 wt. % to 5 wt. %. The stretching ratio, width, thickness, polarizing efficiency, transmittance, and b value of the polarizers are shown in FIG. 6.

### FIRST COMPARISON EXAMPLE

Please refer to FIG. 5. The unstretched PVA films 50 (width 650 mm, thickness 75 μm) are swelled in the swelling tank 68 with pure water, and then dyed in the dyeing tank 70, which comprises iodine solution of concentration between 0.01 wt. % to 1 wt. %. The dyed PVA films are put in the first rinsing tank 72 to rinse, the temperature of the first rinsing tank 72 being 35° C. Then, the rinsed PVA film is stretched in the stretching tank 74, which comprises a solution of 2.56 wt. % adipic acid, 0.3 wt. % Al₂(SO₄)₃·16-18H₂O, and 3.3 wt. % KI. The temperature of the stretching tank 74 is 48° C. Next, the PVA film is rinsed in the second rinsing tank 76, treated in the color fixation tank 78, and finally dried at 60° C. to form the polarizers. The first rinsing tank 72, the second rinsing tank 76, and the color fixation tank 78 comprise boric acid and KI, and the concentration of the boric acid and/or the KI can be adjusted as required, preferably independent of the other, and being in a range of about 1 wt. % to 5 wt. %. The stretching ratio, width, thickness, polarizing efficiency, transmittance, and b value of the polarizers are shown in FIG. 6.

### SECOND COMPARISON EXAMPLE

Please refer to FIG. 5. The unstretched PVA films 50 (width 650 mm, thickness 75 μm) are swelled in the swelling tank 68 with pure water and then dyed in the dyeing tank 70, which comprises iodine solution of concentration between 0.01 wt. % to 1 wt. %. The dyed PVA films are put in the first rinsing tank 72 to rinse. The temperature of the first rinsing tank 72 is 35° C. Then, the rinsed PVA film is stretched in the stretching tank 74, which comprises a solution of 3 wt. % adipic acid, 1 wt. % boric acid, 0.1 wt. %, Zn²⁺ and 4 wt. % KI. The temperature of the stretching tank 74 is 53° C. Next, the PVA film is rinsed in the second rinsing tank 76, treated in the color fixation tank 78, rinsed in the third rinsing tank 80 containing ice water (at 10° C.), and finally dried at 60° C. to form polarizers. The first rinsing tank 72, the second rinsing tank 76, and the color fixation tank 78 comprise boric acid and KI, and the concentration of the boric acid and/or KI can be adjusted as required, preferably independent of the other, and being about 1 wt. % to 5 wt. %. The stretching ratio, width, thickness, polarizing efficiency, transmittance, and b value of the polarizers are shown in FIG. 6.

As shown in FIG. 6, comparing the Preferred Example and the First Comparison Example, the results are as follows: the polarizer made according to the Preferred Example has greater width, better polarizing efficiency, better transmittance and other optical performance, and an acceptable b value. The stretching ratio of the Preferred Example is similar to that of the First Comparison Example (both are higher than in the conventional process). Comparing the Preferred Example and the Second Comparison Example, the results are as follows: the polarizers made according to the Preferred Example and the Second Comparison Example have similar width and similar stretching ratio. However, the difference in thickness between the center and the sides of the polarizer is reduced in the Preferred Example. Because the third rinsing tank is used in the Second Comparison Example, comparison of optical performance cannot be made.

As mentioned above, the method of making the polarizer, or the polarizing sheet, according to the present invention has the following advantages:

(1) The width of the polarizer is increased from 340 mm to 375 mm (the width of the unstretched PVA film is 650 mm).

(2) The stretching ratio is increased from less than 6 to 6.41.

(3) The optical performance is as good as in the conventional process.

(4) The thickness of the polarizer is decreased from a range of 28 μm to 35 μm to a range of 18 μm to 24 μm.

(5) The process taught in the present invention can be integrated into the conventional process easily, for example, by changing the first rinsing tank to the pre-treating tank, and adjusting some parameters.

The First Comparison Example and the Second Comparison Example are embodiments in '826. Although dicarboxylic acid is used to increase the stretchability, boric acid is still used in the present invention. Adipic acid is utilized in the first rinsing tank, and the PVA films are only dipped for a short time in the first rinsing tank. The stretching tank, where the PVA film is dipped for a longer period of time than in the first rinsing tank, contains boric acid, which helps the fixation of the dyed PVA film. So I₂/KI in the PVA film is not easily lost, and the reliability and optical performance of the PVA film are not reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of making a polarizer, comprising:
preparing a polyvinyl alcohol (PVA) film;
performing a dyeing process by dipping the PVA film into a dye-containing solution;
performing a pre-treating process by dipping the PVA film into a first solution, wherein the first solution comprises dicarboxylic acid, and a catalyst catalyzes a surface reaction between the dicarboxylic acid and the pre-treated PVA film; and
dipping the pre-treated PVA film in a second solution and stretching the PVA film, wherein the second solution comprises boric acid.

2. The method according to claim 1, wherein the dye-containing solution comprises iodine.

3. The method according to claim 1, wherein the dye-containing solution comprises potassium iodide.

4. The method according to claim 1, wherein the first solution further comprises potassium iodide.

5. The method according to claim 1, wherein the dicarboxylic acid comprises succinic acid, glutaric acid, adipic acid, or pimelic acid.

6. The method according to claim 1, wherein the catalyst comprises a Lewis acid.

7. The method according to claim 6, wherein the Lewis acid comprises zinc or aluminum ions or comprises metal salts or complexes containing zinc or aluminum ions.

8. The method according to claim 1, wherein the second solution further comprises potassium iodide.

9. The method according to claim 1, wherein the stretching is uniaxial stretching.

10. The method according to claim 1, wherein stretching the PVA film is performed while performing the pre-treating process.

11. A method of making a polarizing sheet, comprising:
preparing a polyvinyl alcohol (PVA) film;
performing a dyeing process by dipping the PVA film into a dye-containing solution;
performing a pre-treating process by dipping the PVA film into a first solution, wherein the first solution comprises dicarboxylic acid, and a catalyst catalyzes a surface reaction between the dicarboxylic acid and the pre-treated PVA film;
dipping the pre-treated PVA film in a second solution and stretching the PVA film, wherein the second solution comprises boric acid; and
laminating the PVA film which is pre-treated and stretched with at least a support film.

12. The method according to claim 11, wherein the dye-containing solution comprises iodine.

13. The method according to claim 11, wherein the dye-containing solution comprises potassium iodide.

14. The method according to claim 11, wherein the first solution further comprises potassium iodide.

15. The method according to claim 11, wherein the dicarboxylic acid comprises succinic acid, glutaric acid, adipic acid, or pimelic acid.

16. The method according to claim 11, wherein the catalyst comprises a Lewis acid.

17. The method according to claim 16, wherein the Lewis acid comprises zinc or aluminum ions, or comprises metal salts or complexes containing zinc or aluminum ions.

18. The method according to claim 11, wherein the second solution further comprises potassium iodide.

19. The method according to claim 11 wherein the stretching is uniaxial stretching.

20. The method according to claim 11, wherein stretching the PVA film is performed while performing the pre-treating process.

21. The method according to claim 11, wherein the support film comprises a triacetyl cellulose (TAC) film.
